(19) United States
(12) Patent Application Publication
(10) Pub. No.: US 2011/0055246 A1
(43) Pub. Date: Mar. 3, 2011

(54) NAVIGATION AND VISUALIZATION OF RELATIONAL DATABASE

(76) Inventors: Yann Le Biannic, Suresnes (FR); Didier Bolf, Boulogne-Billancourt (FR); Alexis L. Naibo, Levallois-Perret (FR)

(21) Appl. No.: 12/551,990

(22) Filed: Sep. 1, 2009

(51) Int. Cl. G06F 17/30

(52) U.S. Cl. 707/769; 707/E17.045; 707/723

(57) ABSTRACT

Navigation and visualization of a relational database may include determination of metadata indicating a structure of the relational database, generation of one or more structured query language queries based on the metadata to retrieve, from the relational database, facet values of each of a plurality of facets of the relational database, determination of a display order of the plurality of facets based on the facet values, and generation of an interface to display of the facet values of the plurality of facets in the determined display order. Also included may be generation of one or more structured query language queries based on the metadata to retrieve aggregated values of a measure for each of the facet values of each of the plurality of facets from the relational database, and generation of the interface to display each of the aggregated values in association with a corresponding facet value in the determined display order.

### BACKGROUND

Business data is typically stored within physical tables of a database. The database may comprise a relational database, such as Oracle, Microsoft SQL Server, IBM DB2, Teradata and the like. The structures and relationships of the physical database tables are complex. To access the stored data, a user with knowledge of the structure and relationships generates specific database-language queries which are intended to extract desired data from the database.

Business Intelligence (BI) tools typically rely on an abstraction layer that shields end users from the complexity of the physical tables. The abstraction layer allows the end users to query a database using intuitive terms rather than references to specific physical entities of the database. However, generation of these queries is beyond the technical capabilities of a typical business user.

Moreover, user-generated queries return only specifically-requested data. Additional queries must be independently generated if additional data is desired. Conventional BI tools therefore do not provide an efficient, navigable presentation of data stored in a database.

Commonly-assigned U.S. Pat. No. 7,493,330, which is incorporated by reference herein for all purposes, describes a system to present data stored in a database. The system initially presents the data in a logically-categorized format, and allows intuitive filtering of and navigation through the presented data. However, the system operates in conjunction with an index of the stored data and aggregations of the stored data, rather than with a standards-based database management system.

Systems are desired for efficiently navigating and visualizing data stored in a database. Such systems preferably employ direct queries to a database using standard query protocols.

### BRIEF DESCRIPTION OF THE DRAWINGS

FIG. 1 is a block diagram of a system according to some embodiments.

FIG. 2 is a representation of a relational database.

FIG. 3 is a representation of an interface to define information space metadata according to some embodiments.

FIG. 4 is a representation of an interface to define information space metadata according to some embodiments.

FIG. 5 is a representation of an interface to define information space metadata according to some embodiments.

FIG. 6 is a block diagram of a system according to some embodiments.

FIG. 7 is a flow diagram of a process according to some embodiments.

FIG. 8 is a representation of an interface to display stored data according to some embodiments.

FIG. 9 is a flow diagram of a process according to some embodiments.

FIG. 10 is a representation of an interface to display stored data based on user-defined filters according to some embodiments.

FIG. 11 is a flow diagram of a process according to some embodiments.

FIG. 12 is a representation of an interface to display stored data based on user-defined filters according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

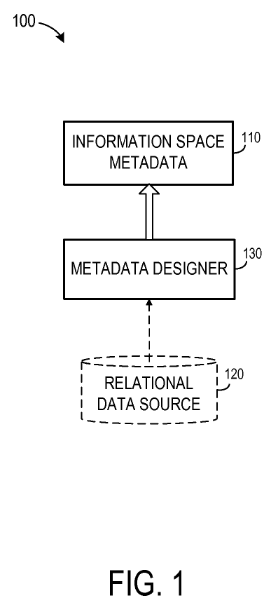

System 100 of FIG. 1 comprises an architecture to define information space metadata 110 associated with a relational data source 120. Relational data source 120 may comprise any query-responsive data source or sources of relational data that are or become known, including but not limited to a structured-query language (SQL) relational database management system.

Metadata designer 130 may comprise a software application to create information space metadata 110 based on relational data source 120. Metadata designer 130 may comprise a standalone, Web-based or other application executing on any computing device or devices that are or become known. Dashed lines are used in FIG. 1 to indicate that a connection between relational data source 120 and metadata designer 130 need not exist before, during, or after generation of information space metadata 110. Such a connection, if established, may comprise any suitable database connection (e.g., Java Database Connector, QT/Connection Server).

Metadata designer 130 may determine a table structure of relational data source 120 directly from relational data source 120, from a structured list, from manual entry thereof by a database administrator, or by other means. The table structure may include a list of tables of data source 120, their constituent columns, and joins therebetween. Such a structure may be referred to as a data foundation, systems for retrieval of which are known in the art.

Detailed examples of information space metadata 110 according to some embodiments are provided below. Briefly, however, information space metadata 110 may include a connection property definition including information for communicating with relational data source 120, and an information space SQL statement to describe a structure of the database tables of data source 120. Information space metadata 110 may also comprise metadata describing business objects of an abstraction layer associated with data source 120.

U.S. Pat. No. 5,555,403 describes such an abstraction layer, referred to therein as a semantic layer. Briefly, an abstraction layer defines a set of “business objects” that represent business entities, such as customers, products, stores, time, sales figures, etc. represented in the data of a data source. Business objects may be classified as dimensions (along which one may want to perform an analysis or report), details (e.g., additional information on dimensions), and measures (e.g., indicators, most often numeric, whose value can be determined for a given combination of dimension values). Commonly-assigned U.S. Pat. No. 7,181,440 describes a system to generate business objects based on a relational data source.

Accordingly, information space metadata 110 may also include metadata associated with dimension objects and measure objects. For each of the dimension objects, the metadata may specify a relational table of data source 120 associated with the dimension object, and one or more column names of the relational table associated with the dimension object. For each of the measure objects, the metadata may specify a relational table associated with the measure object, one or more column names of the relational table associated with the measure object, and an aggregation method (e.g., SUM) associated with the measure object.

The elements of system 100 may be implemented by any suitable combination of hardware and/or software. Each element may be located remotely from one or more other elements. More than one element may be implemented in a single device and/or software package.

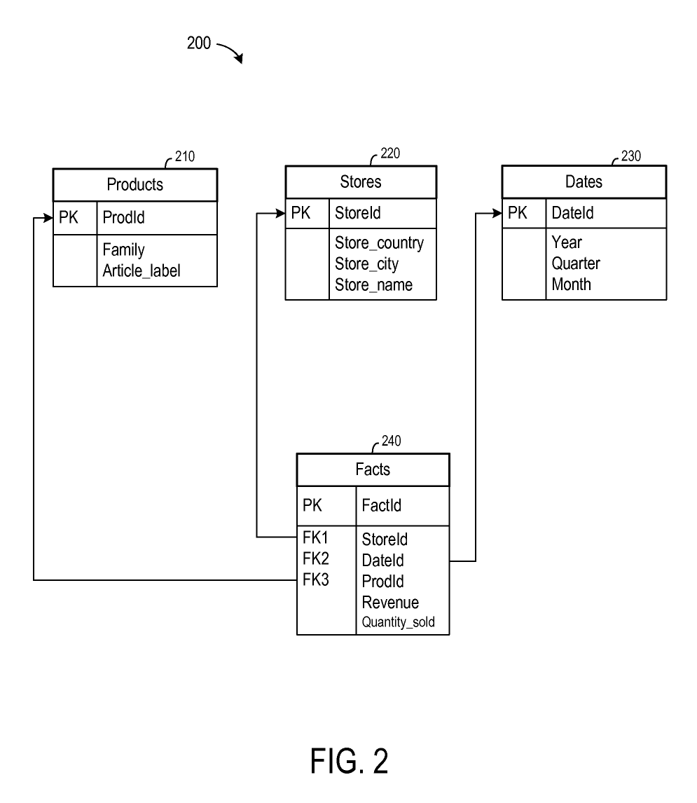

FIG. 2 illustrates structure 200 of a data source for purposes of example. Structure 200 includes Products table 210, Stores table 220, Dates table 230 and Facts table 240, each of which includes associated data columns. Sales table 240 includes a foreign key ProdId to Products table 210, a foreign key StoreId to Stores table 220, and a foreign key DateId to Dates table 230. Embodiments are not limited to structure 200. In some embodiments, one or more foreign key relationships may exist between Products table 210, Stores table 220 and Dates table 230.

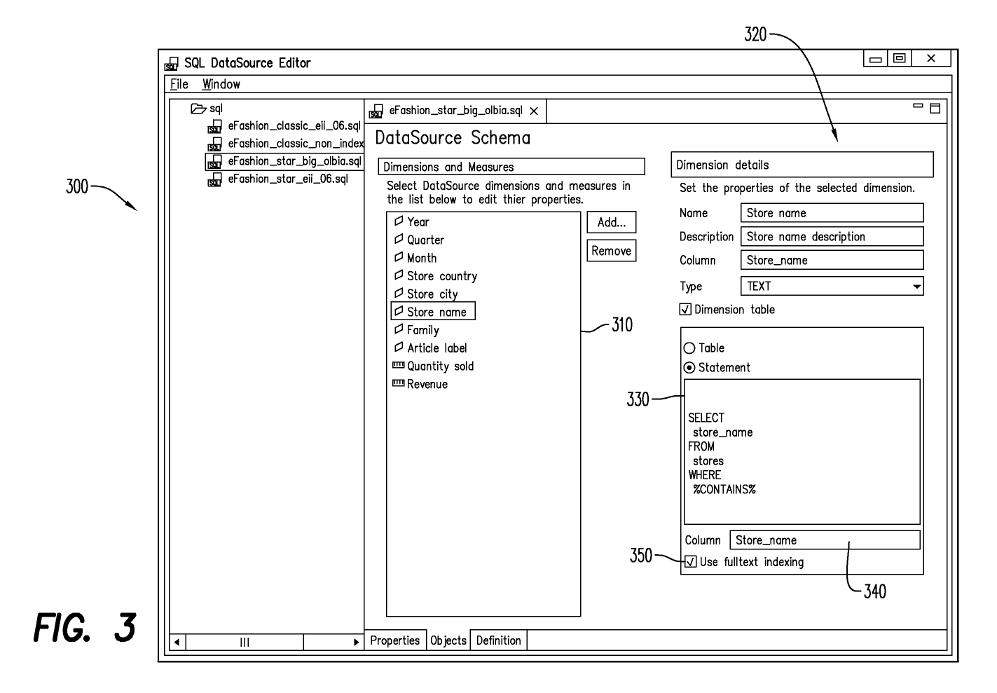

FIG. 3 illustrates interface 300 to define information space metadata according to some embodiments. Interface 300 may be provided by metadata designer 130 to generate information space metadata 110, but embodiments are not limited thereto. Area 310 of interface 300 displays dimension objects and measure objects to be described in metadata. The dimension objects and measure objects of area 310 may have been generated based on structure 200 according to abstraction techniques that are or become known.

Area 320 allows an operator to specify properties of a dimension object selected in area 310. These properties may include, but are not limited to, Name, Description, and Column (i.e., a column of the data source which is associated with the dimension object). Also shown is search property window 330 to define an SQL query for searching the dimension. Window 330 may alternatively specify a table-based search property based on a column specified in field 340. Checkbox 350 is used to indicate whether actual values of the dimension are to be indexed for subsequent searching.

Interface 400 may be provided by metadata designer 130 to generate measure object metadata. A measure object is selected in area 410 of interface 400 and properties thereof are specified in area 420. These properties may include, but are not limited to, Name, Description, and Column (i.e., a column of the data source which is associated with the measure object). Pull-down menu 430 allows an operator to indicate an aggregation method (e.g., SUM, COUNT, MIN, MAX, AVG) associated with the measure object. Usage of a specified aggregation method according to some embodiments is described below.

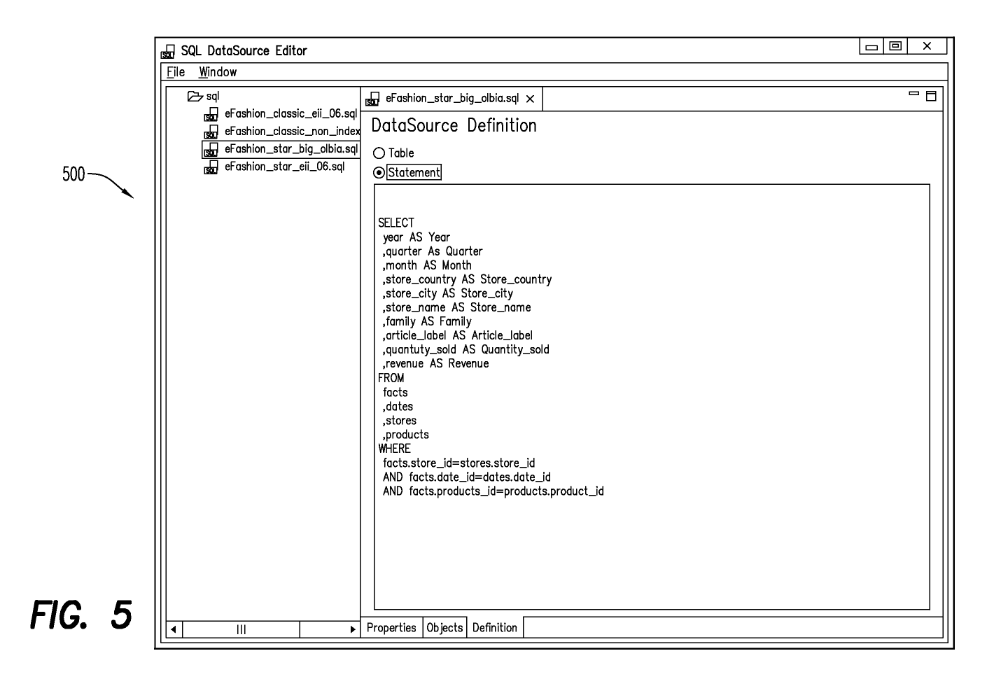

FIG. 5 illustrates interface 500 to define the structure (i.e., data foundation) of the tables of the subject data source. An SQL statement defining the structure is shown in interface 500, but the structure may be defined using a table/view in some embodiments.

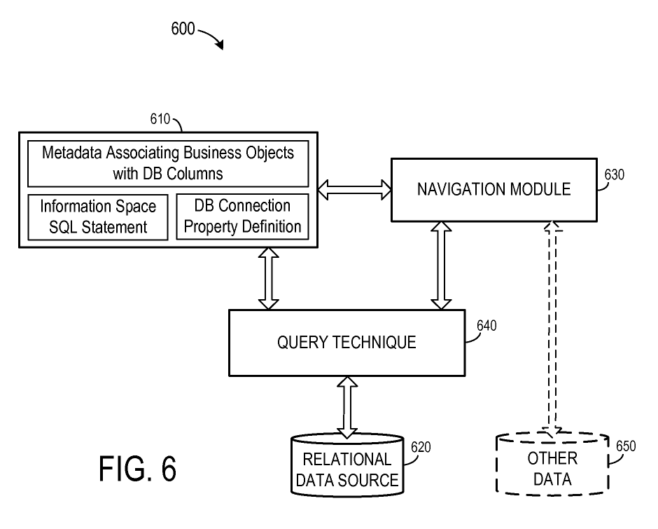

FIG. 6 illustrates runtime architecture 600 according to some embodiments. Information space metadata 610 is associated with relational tables of relational data source 620. Relational data source 620 supports standards-based queries (e.g., SQL queries) according to some embodiments. Information space metadata 610 may have been generated by metadata designer 130 using interfaces 300, 400 and 500, but embodiments are not limited thereto.

As shown, information space metadata 610 includes a Database Connection Property Definition. The Database Connection Property Definition includes information for communicating with relational data source 620. The following is an example of a Database Connection Property Definition according to some embodiments, and based on the data source selected in interfaces 300-500:

```
<datasource>
    <property name=‘datasource-name’
    value=‘eFashion_star_big_olbia’ />
    <property name=‘datasource-description’
value=‘eFashion_star_big_olbia from SQL Server 2005 database’ />
    <property name=‘jdbc-driver-class’
value=‘com.microsoft.sqlserver.jdbc.SQLServerDriver’ />
    <property name=‘connection-url’
value=‘jdbc:sqlserver://eii06:1533;databaseName=eFashion_star;
user=user1;password=password2;’ />
```

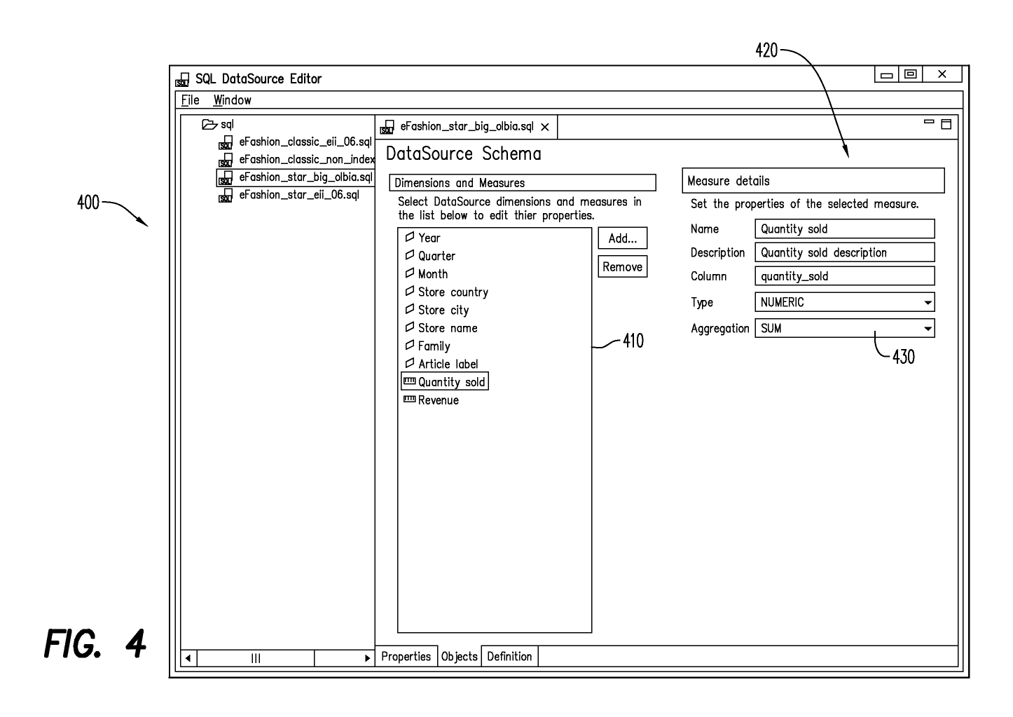

Also continuing with the example of FIGS. 2 through 5, the Metadata Associating Business Objects With Database Columns may appear, in part, as follows:

```
<dimension name=“Year” description=“Year description” type=“TEXT”
columnName=“Year” >
    <statement tableName=“dates” columnName=“year” fulltext=“false” />
</dimension>
<dimension name=“Quarter” description=“Quarter description” type=“TEXT”
columnName=“Quarter” >
    <statement tableName=“dates” columnName=“quarter” fulltext=“true” />
  </dimension>
<dimension name=“Month” description=“Month description” type=“TEXT”
columnName=“Month” />
<dimension name=“Store name” description=“Store name description” type=“TEXT”
columnName=“Store_name”>
    <statement columnName=“store_name” fulltext=“true”>
        <![CDATA[
            SELECT
                store_name
            FROM
                stores
            WHERE
                CONTAINS (store_name, ‘%CONTAINS%’)
        ]]>
    </statement>
  </dimension>
<measure name=“Revenue” description=“Revenue description” type=“NUMERIC”
columnName=“Revenue” aggregationMethod=“SUM” />
```

As mentioned above, this metadata specifies a relational table associated with the dimension object, and one or more column names of the relational table associated with a dimension object. For each measure object, this metadata specifies a relational table associated with the measure object, one or more column names of the relational table associated with the measure object, and an aggregation method associated with the measure object.

Information space 610 further includes an Information Space SQL Statement. This statement may reflect the structure as specified in interface 500 of FIG. 5. For example:

```
<statement>
<![CDATA[
SELECT
  year AS Year ,quarter AS Quarter ,month AS Month ,store_country AS
Store_country ,store_city AS Store_city ,store_name AS
Store_name ,family AS Family ,article_label AS Article_label
,quantity_sold AS Quantity_sold ,revenue AS Revenue
FROM
  facts ,dates ,stores ,products
WHERE
  facts.store_id = stores.store_id
  AND facts.date_id = dates.date_id
  AND facts.product_id = products.product_id
]]>
  </statement>
</datasource>
```

Navigation module 630 comprises hardware and/or software to display data of relational data source 620 based on the metadata of information space metadata 610. This data is acquired by hardware and/or software of query technique 640, also based on the metadata of information space metadata 610. In some embodiments, navigation module 630 may also operate to display and provide navigation through data of other data 650. Other data 650 may comprise a data source such as an index described in the background, the data of which may be accessed using native data access mechanisms of navigation module 630.

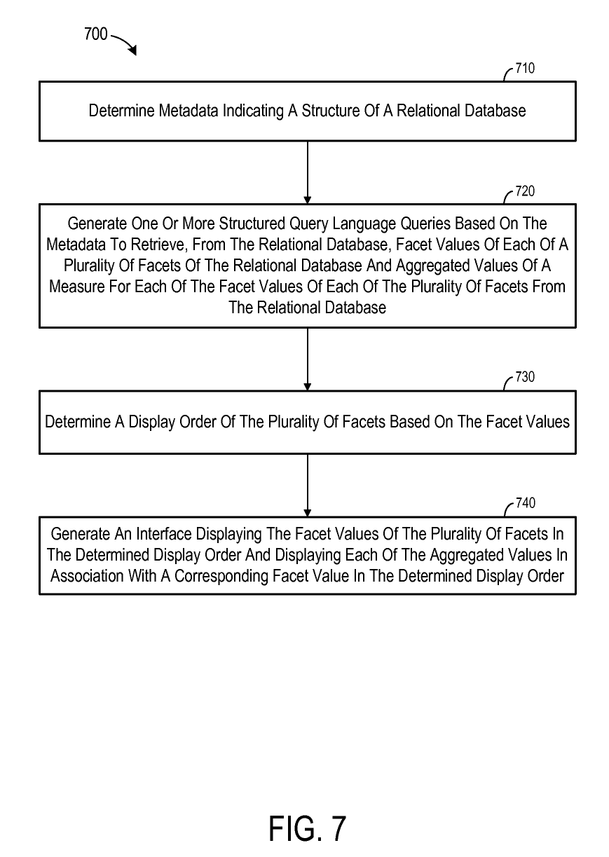

FIG. 7 is a flow diagram of process 700 according to some embodiments. Process 700 may be implemented by navigation module 630 and query technique 640 but embodiments are not limited thereto. In this regard, process 700 may be embodied in computer-executable program code stored on a tangible computer-readable medium. Process 700 may be implemented by any combination of hardware and/or software.

Initially, at 710, metadata indicating a structure of a relational database is determined. For example, the metadata may be determined by creating the metadata as described with respect to FIGS. 2-5, or by accessing already-created metadata indicating the structure of the relational database and stored in information space metadata 610.

Next, at 720, one or more structured query language queries is generated based on the metadata. The one or more structured query language queries are to retrieve, from the relational database, facet values of each of a plurality of facets of the relational database. In this regard, the term facet is used to describe a particular category of data, which in the present example corresponds to a dimension object. Specifically, with reference to the present example, Year, Store City, Store name and Lines are facets, and 2003, Houston, e-Fashion New York and Dresses are facet values.

The one or more structured query language queries are also to retrieve, from the relational database, aggregated values of a measure for each of the facet values of each of the plurality of facets. The measure corresponds to a measure object specified in the metadata.

According to some embodiments of 720, navigation module 630 requests the facets, facet values, and aggregated values from query technique 640. Query technique 640 then uses information space metadata to generate one or more structured query language queries to retrieve the requested data from relational data source 620.

For example, query technique 640 may generate the following queries at 720 based on the example metadata shown above, with “( . . . )” representing the above-described Information Space SQL Statement. Query technique 640 generates four queries beginning with “SELECT TOP 25” because the example includes four facets.

```
    SELECT COUNT(*) FROM (...) AS exploration_space
    SELECT TOP 25 “exploration_space”.“Lines” AS name,
SUM(“exploration_space”.“Quantity_sold”) AS value, COUNT(*) AS count FROM (...)
AS exploration_space GROUP BY “exploration_space”.“Lines” ORDER BY 3 DESC, 2
ASC
    SELECT TOP 25 “exploration_space”.“Store_name” AS name,
SUM(“exploration_space”.“Quantity_sold”) AS value, COUNT(*) AS count FROM (...)
AS exploration_space GROUP BY “exploration_space”.“Store_name” ORDER BY 3
DESC, 2 ASC
    SELECT TOP 25 “exploration_space”.“Store_city” AS name,
SUM(“exploration_space”.“Quantity_sold”) AS value, COUNT(*) AS count FROM (...)
AS exploration_space GROUP BY “exploration_space”.“Store_city “ ORDER BY 3
DESC, 2 ASC
    SELECT TOP 25 “exploration_space”.“Year” AS name,
SUM(“exploration_space”.“Quantity_sold”) AS value, COUNT(*) AS count FROM (...)
AS exploration_space GROUP BY “exploration_space”.“Year” ORDER BY 3 DESC, 2
ASC
```

The facet values retrieved from relational data source 620 at 720 are used at 730 to determine a display order of the retrieved facets. Notably, the display order is based at least in part on the stored data of relational data source 620, rather than solely based on user preferences. The display order may be based on merit values of each facet, as described in aforementioned U.S. Pat. No. 7,493,330. As described therein, a merit value of a facet is based on an entropy value and a coverage value associated with the facet.

An entropy value is calculated for each facet (i.e., category) of data store 620. The entropy value for a facet is based on a number of distinct facet values (i.e., attributes) associated with the facet and a total number of stored data records. It is noted that the above-listed SQL queries result in retrieval of the information needed to calculate the entropy of each facet (i.e., the total number of records, the facet values for each facet, and the number of occurrences of each facet value).

Coverage values are then determined for each facet. A coverage value associated with a facet is a percentage of the total data records which include a facet value of the facet. Next, for each facet, the entropy value is multiplied by the coverage value and the product is normalized to result in a merit value. The display order determined at 730 may reflect an ordering of the facets according to descending merit values. Some embodiments may employ other techniques to determine the display order based on the facet values at 730.

At 740, an interface is generated which displays the facet values of the plurality of facets in the determined display order. The interface also displays each of the aggregated values corresponding to each facet value in association with their corresponding asset value in the determined display order.

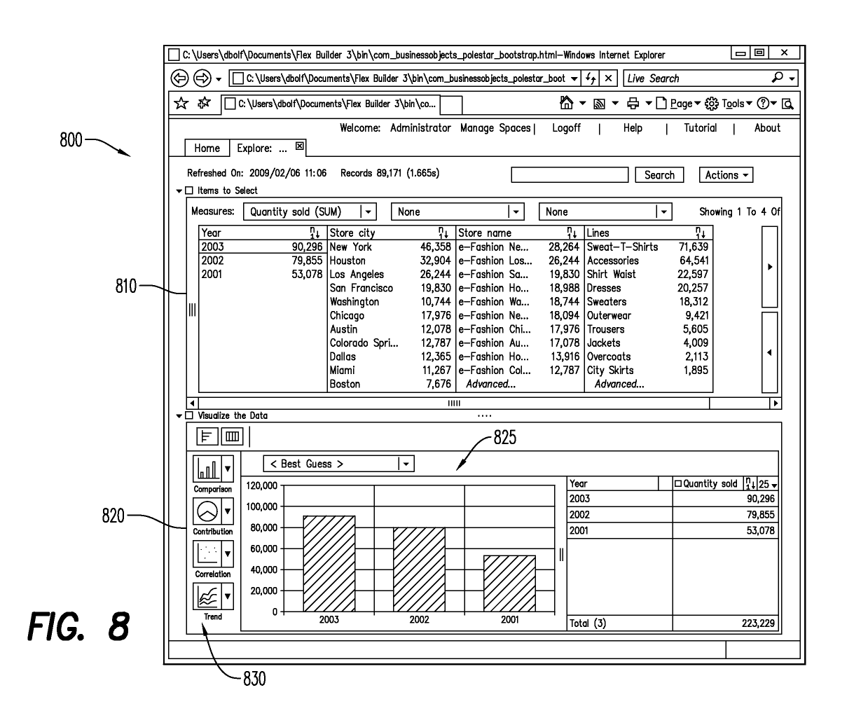

FIG. 8 illustrates interface 800 to display the facet values and the aggregated values according to some embodiments. In some embodiments, a user accesses a Web page provided by navigation module 630 and associated with relational data source 620. In response, navigation module 630 and query technique 640 operate according to process 700 to generate interface 800. Interface 800 is then transmitted to the user for display by a Web browser. Any client application may be used to display interface 800, which is not limited to Web-based formats.

Area 810 of interface 800 displays the facets and their facet values in the determined display order. For example, the merit values determined for each displayed facet may be as follows: Year: 0.49, Store city: 0.35, Store name: 0.23, Lines: 0.18, resulting in the display order: Year, Store City, Store name, Lines. Each facet value is displayed in association with a corresponding aggregated value of the Quantity sold measure.

Again, the information displayed in area 810 may be determined using the above-listed SQL queries, which were in turn determined from the metadata of information space 610. Accordingly, some embodiments may efficiently generate an interface to display stored data of an SQL database in a comprehensible manner based on metadata describing the structure of the database.

Area 820 of interface 800 displays graphic visualization 825 of an aggregated measure value corresponding to each facet value (2001, 2002, 2003) of a first facet (i.e., Year). Buttons 830 allow selection of the graphic visualization type, each of which also displays an aggregated measure value corresponding to each facet value. Data of graphic visualization 825 may be retrieved at 720 of process 700 by generating the following SQL queries:

```
    SELECT TOP 25 “exploration_space”.“Year” AS Facet,
SUM(“exploration_space”.“Quantity_sold”) AS Value0 FROM
(...) AS exploration_space GROUP BY “exploration_space”.“Year“
ORDER BY 2 DESC, 1 ASC
    SELECT COUNT(DISTINCT(“exploration_space”.“Year”))
FROM (...) AS exploration_space
```

Any facet in addition to Year may be referenced in the foregoing SQL queries. In some embodiments, the graphic visualization corresponds to a first facet of the display order. In these cases, the above SQL queries are generated after the display order is determined at 740 of process 700.

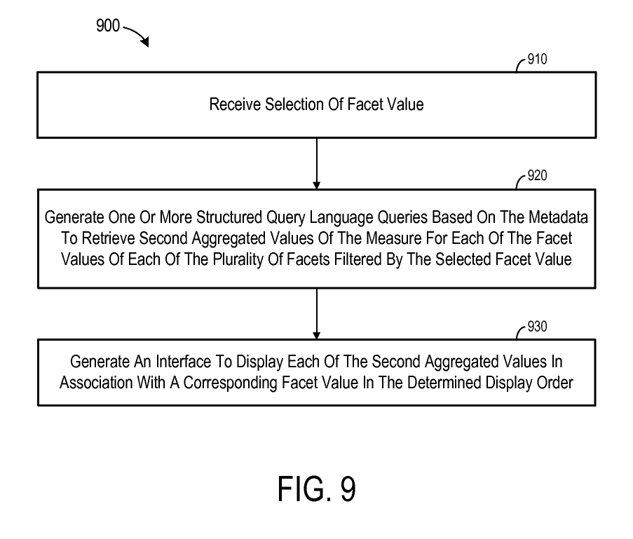

Process 900 of FIG. 9 may also be performed by navigation module 630 and query technique 640 according to some embodiments. Process 900 may be performed after generation of the interface (e.g., interface 800) at 740 of process 700.

A selection of a facet value is received (e.g., by navigation module 630) at 910. Selection of a facet value may comprise selecting a facet value displayed in area 810 (or area 820) of interface 800. The selection is then transmitted to navigation module 630 via known user interface control techniques.

In response to selection of the facet value, one or more structured query language queries are generated at 920 based on metadata indicating a structure of a relational database. The one or more structured query language queries are to retrieve second aggregated values of the measure for each facet value of each facet. The aggregated values are filtered by the selected facet value.

Continuing with the example of FIG. 8, it is assumed that the user has selected the facet value “2003” displayed in area 810. Navigation module 630 receives the selection at 910 and, in response, generates the following queries at 920 based on information space metadata 610:

```
    SELECT COUNT(*) FROM (...) AS exploration_space WHERE
“exploration_space”.“Year”=‘2003’
    SELECT TOP 25 “exploration_space”.“Lines” AS name,
SUM(“exploration_space”.“Quantity_sold”) AS value, COUNT(*) AS count FROM (...)
AS exploration_space WHERE “exploration_space”.“Year”=‘2003’ GROUP BY
“exploration_space”.“Lines” ORDER BY 3 DESC, 2 ASC
    SELECT TOP 25 “exploration_space”.“Store_name” AS name,
SUM(“exploration_space”.“Quantity_sold”) AS value, COUNT(*) AS count FROM (...)
AS exploration_space WHERE “exploration_space”.“Year”=‘2003’ GROUP BY
“exploration_space”.“Store_name” ORDER BY 3 DESC, 2 ASC
    SELECT TOP 25 “exploration_space”.“Store_city” AS name,
SUM(“exploration_space”.“Quantity_sold”) AS value, COUNT(*) AS count FROM (...)
AS exploration_space WHERE “exploration_space”.“Year”=‘2003’ GROUP BY
“exploration_space”.“Store_city” ORDER BY 3 DESC, 2 ASC
    SELECT TOP 1 ‘Year’ AS facet, “exploration_space”.“Year” AS name,
SUM(“exploration_space”.“Quantity_sold”) AS value, COUNT(*) AS count FROM (...)
AS exploration_space WHERE “exploration_space”.“Year”=‘2003’ GROUP BY
“exploration_space”.“Year“ ORDER BY 3 DESC, 2 ASC
```

The foregoing SQL queries retrieve the independent aggregated values of the Quantity sold measure for each facet value of each facet (other than the Year facet), filtered by the facet value “2003”. An interface to display these aggregated values in association with corresponding facet values is generated at 930.

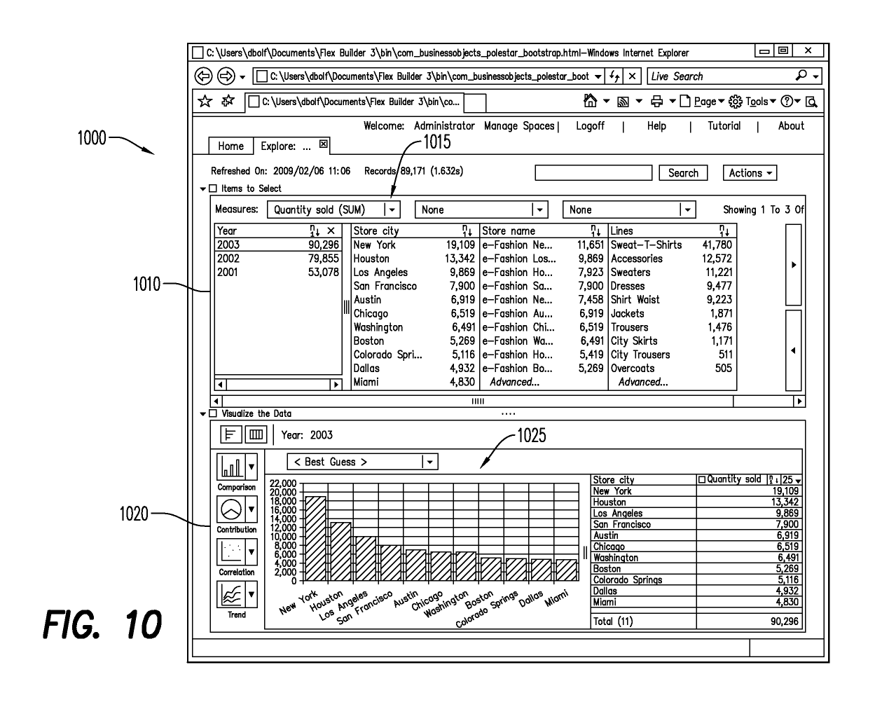

Interface 1000 of FIG. 10 is one example of an interface generated at 930 according to the present example. As shown, Year 2003 is selected in area 1010 and, as a result, area 1010 also shows aggregated values of the Quantity sold measure for each facet value of the Store city, Store name and Lines facets, filtered by the facet value “2003”. In some embodiments, the filtered facet values and record counts obtained by the above-described SQL queries are used to determine a new display order prior to 930, and the facets are displayed according to the new display order.

Area 1020 of interface 1000 displays graphic visualization 1025 of an aggregated measure value corresponding to each facet value of a second facet (i.e., State). The data of graphic visualization 1025 may be retrieved by generating the following SQL queries:

```
    SELECT TOP 25 “exploration_space”.“Store_city” AS Facet,
SUM(“exploration_space”.“Quantity_sold”) AS Value0 FROM (...)
AS exploration_space WHERE “exploration_space”.“Year”=’2003’
GROUP BY “exploration_space”.“Store_city” ORDER BY 2 DESC,
1 ASC
    SELECT COUNT(DISTINCT(“exploration_space”.“Store_city”))
FROM (...) AS exploration_space WHERE
“exploration_space”.“Year”=‘2003’
```

The Store city facet may be represented in graphic visualization 1025 because this facet appears after the Year facet in the display order reflected in area 1010. In some embodiments, the second facet represented in graphic visualization 1025 is user-selectable (i.e., graphic visualization 1025 may display the aggregated Quantity sold in 2003 of each Line).

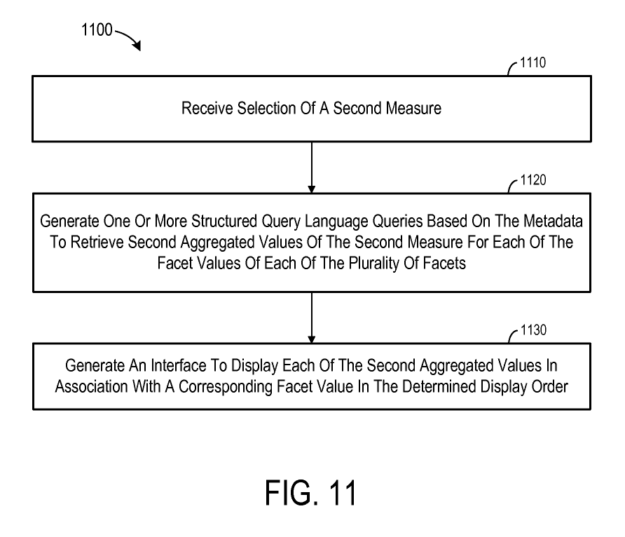

FIG. 11 illustrates process 1100 which may be performed by navigation module 630 and query technique 640 according to some embodiments. Process 1100 may be performed after generation of the interface (e.g., interface 800) at 740 of process 700. In contrast to filtering the presented aggregated values of a measure based on a selected facet value, process 1100 provides presentation of aggregated values of a second measure with respect to already-presented facet values. Process 1100 and process 900 may therefore be employed in conjunction with one another in order to provide efficient navigation through the data stored in a data source.

A selection of a second measure is received at 1110. Selection of a facet value may comprise selecting a new measure in measure bar 1015 of interface 1000. In response to selection of the second measure, one or more structured query language queries are generated at 1120 based on metadata indicating a structure of the present relational database. The one or more structured query language queries are to retrieve second aggregated values of the second measure for each facet value of each facet.

Continuing with the present example, it is assumed that the user has selected a Revenue measure in measure bar 1015. Navigation module 630 receives the selection at 1120 and, in response, generates the following queries at 1120 based on information space metadata 610:

```
    SELECT COUNT(*) FROM (...) AS exploration_space
    SELECT TOP 25 “exploration_space”.“Lines” AS name,
SUM(“exploration_space”.“Revenue”) AS value, COUNT(*) AS count FROM (...) AS
exploration_space GROUP BY “exploration_space”.“Lines“ ORDER BY 3 DESC, 2 ASC
    SELECT TOP 25 “exploration_space”.“Store_name” AS name,
SUM(“exploration_space”.“Revenue”) AS value, COUNT(*) AS count FROM (...) AS
exploration_space GROUP BY “exploration_space”.“Store_name” ORDER BY 3 DESC,
2 ASC
    SELECT TOP 25 “exploration_space”.“Store_city” AS name,
SUM(“exploration_space”.“Revenue”) AS value, COUNT(*) AS count FROM (...) AS
exploration_space GROUP BY “exploration_space”.“Store_city“ ORDER BY 3 DESC, 2
ASC
    SELECT TOP 25 “exploration_space”.“Year” AS name,
SUM(“exploration_space”.“Revenue”) AS value, COUNT(*) AS count FROM (...) AS
exploration_space GROUP BY “exploration_space”.“Year” ORDER BY 3 DESC, 2 ASC
```

These SQL queries retrieve the aggregated values of the Revenue measure for each facet value of each facet. In the present example, it is assumed that information space metadata 160 associates the Revenue measure with an appropriate table column of data source 610 and associates an aggregation method of SUM with the Revenue measure.

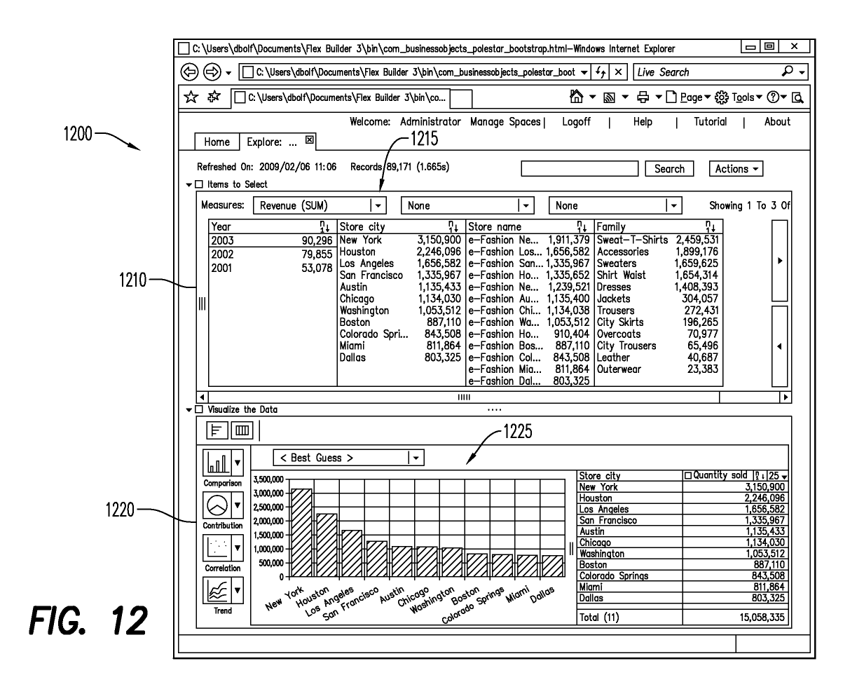

An interface to display these aggregated values in association with corresponding facet values is generated at 1130. Interface 1200 of FIG. 12 is one example of an interface generated at 1130 according to the present example. Measure bar 1215 specifies a Revenue measure and area 1210 also shows aggregated values of the Revenue measure for each facet value of the Year, Store city, Store name and Lines facets.

Since the facet values and record counts obtained by the above SQL queries are the same as those acquired in the example of process 700, the display order of the facets does not change. However, embodiments are not limited thereto, particularly in cases where a different method is used to determine the display order.

Area 1220 of interface 1200 displays graphic visualization 1225 of an aggregated measure value corresponding to each facet value (i.e., 2001, 2002, 2003) of the Year facet. Embodiments are not limited to graphic visualization of the first-ordered facet. The data of graphic visualization 1225 may be retrieved by generating the following SQL queries:

```
    SELECT TOP 25 “exploration_space”.“Year” AS Facet,
SUM(“exploration_space”.“Revenue”) AS Value0 FROM (...)
AS exploration_space GROUP BY “exploration_space”.“Year“
ORDER BY 2 DESC, 1 ASC
    SELECT COUNT(DISTINCT(“exploration_space”.“Year”))
FROM (...) AS exploration_space
```

Embodiments described herein are solely for the purpose of illustration. Those in the art will recognize other embodiments may be practiced with modifications and alterations to that described above.

What is claimed is:

1. A method comprising:
determining metadata indicating a structure of a relational database;
generating one or more structured query language queries based on the metadata to retrieve, from the relational database, facet values of each of a plurality of facets of the relational database;
determining a display order of the plurality of facets based on the facet values; and
generating an interface displaying the facet values of the plurality of facets in the determined display order.

2. A method according to claim 1,
wherein generating the one or more structured query language queries comprises generating one or more structured query language queries based on the metadata to retrieve aggregated values of a measure for each of the facet values of each of the plurality of facets from the relational database, and
wherein generating the interface comprises generating the interface displaying each of the aggregated values in association with a corresponding facet value in the determined display order.

3. A method according to claim 2, further comprising:
receiving a selection of a facet value of a first facet;
in response to the received selection, generating one or more structured query language queries based on the metadata to retrieve, from the relational database, second aggregated values of the measure for each facet value of each of the plurality of facets filtered by the selected facet value; and
generating an interface displaying each of the second aggregated values in association with a corresponding facet value.

4. A method according to claim 3, further comprising:
prior to the received selection, generating an interface displaying a graphic visualization of the aggregated measure value corresponding to each facet value of the first facet; and
in response to the received selection, generating an interface displaying a graphic visualization of the second aggregated measure value corresponding to each facet value of a second facet of the plurality of facets.

5. A method according to claim 3, further comprising:
receiving a second selection of a facet value of a second facet while the facet value of the first facet is selected;
in response to the received second selection, generating one or more structured query language queries based on the metadata to retrieve, from the relational database, third aggregated values of a measure for each facet value of each of the plurality of facets filtered by the selected facet value of the first facet and the selected facet value of the second facet; and
generating an interface displaying each of the third aggregated values in association with a corresponding facet value.

6. A method according to claim 5, further comprising:
prior to the received selection, displaying a graphic visualization of the aggregated measure value corresponding to each facet value of the first facet;
in response to the received selection, generating an interface displaying a graphic visualization of the second aggregated measure value corresponding to each facet value of the second facet of the plurality of facets; and
in response to the received second selection, generating an interface displaying a graphic visualization of the third aggregated measure value corresponding to each facet value of a third facet of the plurality of facets.

7. A method according to claim 2, wherein determining the display order of the plurality of facets comprises:
determining an entropy of each of the plurality of facets based on the facet values; and
determining the display order based on the entropy.

8. A method according to claim 1, wherein determining the display order of the plurality of facets comprises:
determining an entropy of each of the plurality of facets based on the facet values; and
determining the display order based on the entropy.

9. A method according to claim 1, further comprising:
receiving a selection of a second measure;
generating one or more structured query language queries based on the metadata to retrieve, from the relational database, aggregated values of the second measure for each of the facet values of each of the plurality of facets; and
generating an interface displaying each of the aggregated values of the second measure in association with a corresponding facet value in the determined display order.

10. A method according to claim 9, further comprising:
receiving a selection of a facet value of the first facet;
in response to the received selection, generating one or more structured query language queries based on the metadata to retrieve, from the relational database, second aggregated values of the second measure for each facet value of each of the plurality of facets filtered by the selected facet value; and
generating an interface displaying each of the second aggregated values of the second measure in association with a corresponding facet value.

11. A tangible computer-readable medium having stored thereon program code, the program code executable by a computer to:
determine metadata indicating a structure of a relational database;
generate one or more structured query language queries based on the metadata to retrieve facet values of each of a plurality of facets of the relational database;
determine a display order of the plurality of facets based on the facet values; and
generate an interface to display the facet values of the plurality of facets in the determined display order.

12. A medium according to claim 11, the program code to generate one or more structured query language queries further comprising program code executable by a computer to:
generate one or more structured query language queries based on the metadata to retrieve, from the relational database, aggregated values of a measure for each of the facet values of each of the plurality of facets; and
the program code to generate the interface further comprising program code executable by a computer to:
generate the interface to display each of the aggregated values in association with a corresponding facet value in the determined display order.

13. A medium according to claim 12, the program code further executable by a computer to:
receive a selection of a facet value of a first facet;
in response to the received selection, generate one or more structured query language queries based on the metadata to retrieve, from the relational database, second aggregated values of the measure for each facet value of each of the plurality of facets filtered by the selected facet value; and
generate an interface to display each of the second aggregated values in association with a corresponding facet value.

14. A medium according to claim 13, the program code further executable by a computer to:
prior to the received selection, generate an interface to display a graphic visualization of the aggregated measure value corresponding to each facet value of the first facet; and
in response to the received selection, generate an interface to display a graphic visualization of the second aggregated measure value corresponding to each facet value of a second facet of the plurality of facets.

15. A medium according to claim 13, the program code further executable by a computer to:
receive a second selection of a facet value of a second facet while the facet value of the first facet is selected;
in response to the received second selection, generate one or more structured query language queries based on the metadata to retrieve, from the relational database, third aggregated values of the measure for each facet value of each of the plurality of facets filtered by the selected facet value of the first facet and the selected facet value of the second facet; and
generate an interface to display each of the third aggregated values in association with a corresponding facet value.

16. A medium according to claim 15, the program code further executable by a computer to:
prior to the received selection, generate an interface to display a graphic visualization of the aggregated measure value corresponding to each facet value of the first facet;
in response to the received selection, generate an interface to display a graphic visualization of the second aggregated measure value corresponding to each facet value of the second facet of the plurality of facets; and
in response to the received second selection, generate an interface to display a graphic visualization of the third aggregated measure value corresponding to each facet value of a third facet of the plurality of facets.

17. A medium according to claim 12, wherein the program code executable by a computer to determine the display order of the plurality of facets comprises program code executable by a computer to:
determine an entropy of each of the plurality of facets based on the facet values; and
determine the display order based on the entropy.

18. A medium according to claim 11, wherein the program code executable by a computer to determine the display order of the plurality of facets comprises program code executable by a computer to:
determine an entropy of each of the plurality of facets based on the facet values; and
determine the display order based on the entropy.

19. A medium according to claim 11, the program code further executable by a computer to:
receive a selection of a second measure;
generate one or more structured query language queries based on the metadata to retrieve, from the relational database, aggregated values of the second measure for each of the facet values of each of the plurality of facets; and
generate an interface to display each of the aggregated values of the second measure in association with a corresponding facet value in the determined display order.

20. A medium according to claim 19, the program code further executable by a computer to:
receive a selection of a facet value of the first facet;
in response to the received selection, generate one or more structured query language queries based on the metadata to retrieve second aggregated values of the second measure for each facet value of each of the plurality of facets filtered by the selected facet value; and
generate an interface to display each of the second aggregated values of the second measure in association with a corresponding facet value.

21. A system comprising:
a database of relational tables and data values stored in the relational tables; and
information space metadata comprising:
a connection property definition comprising information for communicating with the database;
dimension object metadata associated with a plurality of dimension objects, the dimension object metadata comprising, for each of the plurality of dimension objects, one of the relational tables associated with the dimension object, and one or more column names of the one of the relational tables associated with the dimension object;
measure object metadata associated with one or more measure objects, the measure object metadata comprising, for each of the one or more measure objects, one of the relational tables associated with the measure object, one or more column names of the one of the relational tables associated with the measure object, and an aggregation method associated with the measure object; and
an information space structured query language statement to describe a structure of the relational tables; and
a navigation module to:
generate one or more structured query language queries based on the information space metadata to retrieve data values of a column corresponding to each of the plurality of dimension objects from the database;
determine a display order of the plurality of dimension objects based on the retrieved data values; and
generate an interface to display the data values of a column corresponding to each of the plurality of dimension objects in the determined display order.

22. A medium according to claim 21,
wherein generation of the one or more structured query language queries comprises generation of one or more structured query language queries based on the information space metadata to retrieve aggregated values of a measure object for each of the data values of each of the plurality of dimension objects from the database, and
wherein generation of the interface comprises generation of the interface to display each of the aggregated values in association with a corresponding data value in the determined display order.

23. A medium according to claim 22, the navigation module to:
receive a selection of a data value of a dimension object;
generate, in response to the received selection, one or more structured query language queries based on the information space metadata to retrieve second aggregated values of the measure for each data value of each of the plurality of dimension objects filtered by the selected data value from the database; and
generate an interface to display each of the second aggregated values in association with a corresponding data value.

24. A medium according to claim 23, the navigation module to:
generate an interface to display, prior to the received selection, a graphic visualization of the aggregated value of the measure object for each of the data values of the first dimension object; and
generate an interface to display, in response to the received selection, a graphic visualization of the second aggregated values of the measure for each data value of a second dimension object.

25. A medium according to claim 23, the navigation module to:
receive a second selection of a data value of a second dimension object while the data value of the first dimension object is selected;
generate, in response to the received second selection, one or more structured query language queries based on the metadata to retrieve, from the database, third aggregated values of a measure for each data value of each of the plurality of dimension objects filtered by the selected data value of the first dimension object and the selected data value of the second dimension object; and
generate an interface to display each of the third aggregated values in association with a corresponding data value.

26. A medium according to claim 25, the navigation module to:
generate an interface to display, prior to the received selection, a graphic visualization of the aggregated measure value corresponding to each data value of the first dimension object;
generate an interface to display, in response to the received selection, a graphic visualization of the second aggregated measure value corresponding to each data value of the second dimension object of the plurality of dimension objects; and
in response to the received second selection, generate an interface to display a graphic visualization of the third aggregated measure value corresponding to each data value of a third dimension object of the plurality of dimension objects.

27. A medium according to claim 21, the navigation module to:
receive a selection of a second measure object;
generate one or more structured query language queries based on the metadata to retrieve aggregated values of the second measure object for each of the data values of each of the plurality of dimension objects from the database; and
generate an interface to display each of the aggregated values of the second measure object in association with a corresponding data values in the determined display order.

28. A medium according to claim 27, the program code further executable by a computer to:
receive a selection of a data value of the first dimension object;
generate, in response to the received selection, one or more structured query language queries based on the metadata to retrieve second aggregated values of the second measure object for each data value of each of the plurality of dimension objects filtered by the selected data value; and
generate an interface to display each of the second aggregated values of the second measure object in association with a corresponding data value.
